(19) United States
(12) Patent Application Publication
(10) Pub. No.: US 2014/0157985 A1
(43) Pub. Date: Jun. 12, 2014

(54) Dehumidification Systems and Methods Thereof

(71) Applicant: University of Mississippi, University, MS (US)

(72) Inventors: Paul Scovazzo, Oxford, MS (US); Anthony J. Scovazzo, Alexandria, VA (US)

(73) Assignee: University of Mississippi, University, MS (US)

(21) Appl. No.: 14/115,612

(22) PCT Filed: May 3, 2012
(86) PCT No.: PCT/US12/36368

§ 371 Date: Jan. 9, 2014

Related U.S. Application Data
(60) Provisional application No. 61/481,979, filed on May 3, 2011.

(51) Int. Cl. B01D 53/26

(52) U.S. Cl. CPC B01D 53/268
USPC 95/52; 96/4; 96/10; 96/14; 29/890.07

(57) ABSTRACT

An apparatus for removing water vapor from a feed gas is provided that comprises a membrane housing, a membrane that divides a first pressure side and a second pressure side of the membrane housing, a feed gas inlet and outlet on the first pressure side, a sweep gas inlet and outlet on the second pressure side, a sweep gas flow regulator, and a pump. In some embodiments the feed gas can be at ambient pressure and a pressure drop across the membrane can be less than about 1 atm. In some embodiments the sweep gas can be a portion of the feed gas exiting the first pressure side. Some embodiments are part of air conditioning, drying, or water recovery systems. Additionally, some embodiments achieve dew points of less than 0° C. and dehumidification efficiencies of 200% to 600%.

### CROSS-REFERENCE TO RELATED APPLICATIONS

This application claims priority from U.S. Provisional Patent Application No. 61/481,979, filed May 3, 2011, the entire disclosure of which is incorporated herein by this reference.

### FIELD OF THE INVENTION

The present invention generally relates membrane dehumidification systems, and more particularly to water permeable membrane systems for dehumidifying gases at ambient pressure. The present invention also relates to membrane systems for dehumidifying gases at ambient pressure that utilize a sweep gas to sweep a permeate side of a membrane.

### Introduction

Membrane systems for the dehumidification of gas streams have previously been proposed for natural gas (13) (14) (15) (16), ethanol, and compressed gas. In the context of compressed gas, the humid feed gas is generally at pressures greater than 100 psia (7 bars). However, in the context of membrane systems with the humid feed gas at standard atmospheric pressures (≈1 bar), the literature and research is limited. Bend Research (9) and Kneifel et al. (10) have previously looked at designing membrane modules for dehumidifying air that have proper mass transfer capabilities and minimum treated gas pressure drops. The Kneifel et al. (10) system used an aqueous salt flowing on the permeate side of the membrane to establish the driving force for the humidity mass transfer via absorption. El-Dessouky et al. (7) did a paper study and simulation of the energy savings of adding a membrane-based dehumidifier without a recycle sweep in the permeate, prior to sensible heat removal via evaporative cooling in an integration air conditioning system. El-Dessouky et al.'s conclusion was that such a design could lead to an 86% energy saving compared to using only a conventional coiling coil system (e.g., a vapor compression refrigeration cycle). These estimated savings indicate that there is a superior and unexpected potential for energy savings with the present invention.

The removal of humidity from air flowing in an air conditioning (AC) system saves the overall energy of the AC system. It also reduces the required capacity of a refrigeration plant, thus reducing operating cost, capital cost, and discharged fluorocarbons, which are greenhouse gases, into the atmosphere.

This need for humidity control has long been identified. For example “the relative humidity should not exceed 60% at any point in the occupied space . . . .” (ASHRAE Handbook of Fundamentals, 1972, Chapter 33 p 667). ASHRAE (American Society of Heating, Refrigerating and Air-Conditioning Engineers) was founded in 1894 and it handbook and standards are often cited in building codes. Additional reference from ASHRAE is Standard 55-66 (published in 1966). ASHRAE's Thermal Comfort Conditions specify comfort conditions and humidity control in further detail. While control of humidity by overcooling/reheating and by desiccant drying processes has long been applied and understood, both of these methods are energy intensive and hard to control. Therefore, the recommendation for humidity control, from the middle of the last century, is still not widely applied, further indicating an unmet need.

The process of removing water vapor from gases has a number of names; such as, dehumidification, dehydration, humidity controlled air conditioning, etc. It is an energy intensive and widely needed process in industrial manufacturing and air conditioning. For example, air conditioning represents 50% of a building's energy use and is critical for worker productivity, manufacturing quality, and health. For these critical outcomes, humidity control, not temperature control, is the primary function of the air conditioning.

For instance, building occupants are more comfortable if the humidity is controlled within a defined range. This range is generally 30% to 60% relative humidity, but varies slightly with dry bulb temperature and clothing (ASHRAE Standard #55). The economic impact of this comfort is increased worker productivity. Reducing humidity in an occupied space also leads to a cooler feeling. Some occupants overcome the humid feeling by reducing the dry-bulb temperature, but not the humidity, of the space. This is a compromise between feeling too cold rather than too humid, which is uncomfortable but currently widely accepted. Humidity is also an important consideration in manufacturing quality control, particularly when using hygroscopic materials, and avoiding corrosion on machined metal parts.

Worker health can be a significant concern. If humidity is too low, the drying of the mucus membranes reduces the body's immune system. If humidity is too high, environmental mold and mildew growth increase. Therefore, controlling humidity within a narrow range promotes good health practices in the workplace.

Current technologies, are energy intensive and lack precise control. Water phase change is common to the technologies currently in use, which change the temperature of a gas while removing humidity. This requires the application of a second process to return the gas temperature to the original or another desired temperature. These multiple step processes are energy intensive and difficult to control with precision. The two current technologies for air conditioning dehumidification are cooling coil and desiccant cycle.

Cooling Coil: In this process, a cold coil, which may be finned, is placed in the gas stream. The temperature of the coil must be slightly below the desired wet bulb temperature of the dehumidified gas. Humidity condenses out of the gas onto the cold surface of the coil. The gas stream leaving the coil is at the desired dew point temperature, and the dry bulb temperature is only slightly above the dew point temperature. The gas must then be heated to the desired dry bulb temperature. This reheating of the gas represents an additional energy penalty required to dehumidify the gas. A conventional Vapor Compression Refrigeration Cycle (VCC) could produce cool coils and could also supply reheat energy.

Desiccant Cycle: This is a three step process. In the first step, the desiccant, exposed to the humid gas, adsorbs the humidity from the gas. This is an exothermal step, so the gas heats up as the water vapor absorbs. Before this gas can be used it must then be cooled to the desired delivery temperature. In the second step, high grade heat regenerates the desiccant. Heating the desiccant increases the surface vapor pressure above the vapor pressure of the surrounding gas, and the moisture leaves the desiccant. The third step is to cool the desiccant so that its water vapor pressure will be below the vapor pressure in the processed gas. Energy is therefore used in both cooling the air after the desiccant step and in the regeneration step.

In general, the design of an air conditioning system provides the proper balance between sensible cooling and humidity control based on a “standard day” for a particular location. The system controls to a set-point temperature based on the humidity level of the “standard day.” There is no measurement of the humidity or control of the process based on humidity. The amount of dehumidification achieved is a function of the run time determined by the temperature controller and often little actual humidity control occurs. This is because the design conditions of the “standard day” occur for only a few hours of each year. During the remaining hours, the temperature and humidity vary with little relation to each other. Often the humidity can be higher than design criteria when the dry-bulb temperature is lower than design criteria. When this occurs the humidity within a space may rise significantly.

If humidity control is applied at all, three technologies are currently applied: reheat cycle, desiccant drying, and humidity exchanger. The most common of the currently applied technologies is the reheat cycle. This involves overcooling the air with VCC air conditioning, resulting in both a decrease in latent heat and sensible heat of the air mass. The air mass now being too cold (i.e. 12° C.) is reheated to the desired condition (i.e. 23° C.). The second technology uses a desiccant drying system. This process removes latent heat from the air mass but adds sensible heat to the air mass. The overheated air is then re-cooled to the desired condition. In either of these first two technologies, energy is wasted moving along the temperature scale for water vapor removal only to move back toward the original temperature of the air mass for comfort or health. The use of water phase change as the dehumidification mechanism dictates this movement along the temperature scale. Phase change is not the mechanism in the present invention.

The third technology is to use a humidity exchanger between the process air and waste air stream. This is usually a heat wheel coated with a desiccant, but a few plate type humidity exchangers are available and several liquid desiccant systems are also in use. This process does not serve as humidity control because it will not result in the removal of all the water vapor required. It is used as a pretreatment to humidity control and is effective in reducing the energy cost of humidity control in some climates but not all regions of the world.

Historically, a membrane process establishes a partial pressure difference across the membrane by operating the feed and permeate streams at different absolute pressures. For instance, compressed air systems use a feed stream that is ≧100 psig while operating the permeate stream at ambient pressures. Alternatively, the feed gas could be at ambient pressure and a vacuum pump may be attached to the permeate (7). For humidity controlled air conditioning systems the former is impractical and the later results in a very small driving force, ΔF. For example, if a vacuum permeate membrane system has a high water selectivity (Table 1) then the vacuum pump attached to the permeate stream must maintain an absolute pressure of less than 12 mmHg (0.232 psia or 29.45 in Hg of vac) for practical air conditioning results.

A number of membrane systems in the literature are variations on the existing technologies; namely, cooling coil and absorption. Membrane manifestations of the cooling coil, or “membrane condensers,” have been used for humidity control in microgravity environments (17) and proposed as a means to improve the efficiency of condenser (clothes) dryers (1). While these are novel applications of membrane technologies, these “membrane condensers” still dehumidify air by cooling it and give no practical advantage for air conditioning over standard cooling coil technology. Membrane manifestation of absorption may use aqueous salt solutions; such as LiCl (10). These membrane systems are variations on the existing desiccant cycles. The membrane serves only as a method of contacting the humid air with the desiccant.

Several patent documents specify a compressed or pressurized gas feed with a portion of the retentate used as a permeate sweep. The following are representative of these high pressure feed patents: U.S. Pat. No. 6,540,818, describing compressed air feed, retentate “reflux” as sweep; U.S. Pat. No. 5,259,869, describing pressurized feed, retentate sweep, no specification on permeate pressure; U.S. Pat. Nos. 4,793,830 and 4,687,578, describing feed “compressed to at least one atmosphere” with an ambient pressure retentate sweep. Thus, high pressure membrane systems exist for dehumidifying industrial gases (2). Some of these units recycle a portion of the produced gas to aid in establishing the driving force for the dehumidification process. These industrial membrane systems operate with a cross membrane pressure drop of greater than 6.5 atmospheres. However, known membrane systems for dehumidifying atmospheric pressure gases suffer from low driving forces across the membrane.

The following patents are also of note, as representations of the state of the art: U.S. Pat. No. 4,718,921, limited to hollow filaments made of aromatic imide polymer with retentate sweep, and preferably having pressurized gas feeds and ambient permeate pressures made in the retentate sweep claim; U.S. Pat. No. 4,900,448, limited to hollow fiber membranes and vacuum only with no vacuum retentate sweep; U.S. Pat. No. 5,681,368, limited to pressurized feed and vacuum permeate with no retentate sweep; U.S. Pat. No. 5,525,143, limited to hollow fiber membranes with internal module sweep gas generation; U.S. Pat. No. 4,783,201, using “sufficiently porous membranes” to create the retentate sweep via “leaking membranes.”

Proposals to use membrane systems for humidity control date back to before October 2000, when El-Dessouky et al. (7) published a study that a successfully designed membrane air drying system could result in 86.2% energy savings over commonly used conventional mechanical vapor compressor air conditioners. However, to date no such system is available in the market, indicating an unmet need with a significant commercial value potential.

Accordingly, there remains a long-felt but unmet need for systems that can dehumidify gases isothermally. There remains a need for cost-effective and efficient dehumidification of gases that are at about ambient pressure, such as gases in air conditioning units and dryers. There also remains a need for a membrane dehumidification unit that can remove water vapor from gases with a relatively low pressure drop (e.g., less than about 6.5 atm) across the membrane.

### SUMMARY

This Summary lists several embodiments of the presently invention, and in many cases lists variations and permutations of these embodiments. This Summary is merely exemplary of the numerous and varied embodiments. Mention of one or more representative features of a given embodiment is likewise exemplary. Such an embodiment can typically exist with or without the feature(s) mentioned, likewise, those features can be applied to other embodiments of the presently disclosed subject matter, whether listed in this Summary or not. To avoid excessive repetition, this Summary does not list or suggest all possible combinations of such features.

Embodiments of the present invention include apparatuses and methods for removing water vapor from a gas. Some embodiments of the present invention use a membrane process for humidity control that is substantially different than the technologies currently used for humidity control and that resolve the above-discussed unmet needs. In some embodiments the apparatus for removing water vapor from gas comprises a membrane, a membrane housing comprising a first pressure side and a second pressure side, with the membrane dividing the first pressure side from the second pressure side, a feed gas inlet directing a feed gas with a first humidity into the first pressure side and in contact with the membrane, a feed gas outlet on the first pressure side, a sweep gas inlet directing a sweep gas with a second humidity into the second pressure side and in contact with the membrane, a sweep gas outlet on the second pressure side allowing the sweep gas and a permeate to exit the membrane, a sweep gas flow regulator to direct the sweep gas into the second pressure side, and a pump that imparts a lower pressure in the second pressure side and directs the sweep gas through the second pressure side, wherein water vapor from the feed gas is drawn through the membrane into the second pressure side as the permeate.

In some embodiments the sweep gas flow regulator is an expansion valve, a throttling device, a valve, a capillary tube, or an orifice, and the orifice can be an opening in the membrane. The sweep gas flow regulator can be within the membrane housing and/or outside the membrane housing.

In some embodiments the apparatus further comprises a flow splitter to direct a re-directed portion of the feed gas exiting the first pressure side to the second pressure side as the sweep gas. The re-directed portion can be about 0.1% to about 99.9%, about 0.1% to about 50%, or about 0.1% to about 20% of the gas exiting the feed gas outlet, for example.

In some embodiments of the apparatus, a pressure in the second pressure side is lower than a pressure in the first pressure side. In some embodiments the feed gas enters the first pressure side at ambient pressure. Also, in some embodiments a pressure in the second pressure side is about 200 mmHg-absolute or less, about 100 mmHg-absolute or less, or about 50 mmHg-absolute or less.

Some embodiments of the present invention further comprise a water collection device to collect condensed water vapor from the feed gas, and the water collection device can be attached to the second pressure side of the membrane housing and/or be downstream of the sweep gas outlet.

The membrane in some embodiments is a spiral wound membrane, a tubular membrane, a hollow fiber membrane, a flat sheet membrane, a capillary membrane, or combinations thereof. The membrane can be a water permeable membrane, a semi-permeable membrane, or combinations thereof, and specific examples of membranes comprise polydimethylsiloxane, cellulose acetate, sulfonated polyethersulfone, polyethylene oxide, sulfonated poly(ether ether ketone), poly(vinylalcohol)-EDTMPA, [emim][Tf₂N], [N(4)111][Tf₂N], [emim][BF₄], or combinations thereof.

Some embodiments of the present invention can achieve feed gas in the feed gas outlet having a dew point of about −42° C. to about 35° C., and can have dehumidification efficiencies of about 50% to about 600%.

Some embodiments further comprising a recycle loop that is in fluid communication with the feed gas inlet and the feed gas outlet or a recycle loop that is in fluid communication with the sweep gas outlet and the feed gas inlet. The recycle loop can connect a gas outlet of a water collection device to the feed gas inlet in some embodiments.

Some embodiments are part of a heating system, a ventilation system, an air conditioning system, a drying system, a liquid recovery system, or combinations thereof. For example, the feed gas in the feed gas outlet can enter a drying system. Also, a dryer gas from an outlet of the drying system is recycled to the feed gas inlet in some embodiments.

Embodiments of the present invention also comprise a method for manufacturing the above described embodiments of the present invention as well as variations thereof. Furthermore, other embodiments comprise methods for removing water vapor from gas comprising providing an embodiment of the present invention described above as well as variations thereof, delivering the feed gas to the feed gas inlet, vacuuming the second pressure side with the pump to provide the sweep gas to the second pressure side and drive water vapor through the membrane, and collecting a product.

In some embodied methods the product is the feed gas from the feed gas outlet, water vapor collected from a water collection device, or combinations thereof.

In some embodiments the feed gas that is to have water vapor removed is air, oxygen, nitrogen, methane, biomethane, ethane, ethylene, ethanol, butane, butanol, or combinations thereof. In some embodiments the sweep gas is a portion of the feed gas from the feed gas outlet, a preselected gas, or combinations thereof.

In some embodiments the feed gas enters the first pressure side at ambient pressure and the sweep gas comprises a portion of the feed gas.

Embodiments of the present invention also comprise a plurality of the above described embodiments of apparatuses as well as variations thereof, wherein the plurality of apparatuses are connected together to establish concurrent flow, countercurrent flow, cross-flow flow, or combinations thereof.

Further advantages of the presently-disclosed subject matter will become evident to those of ordinary skill in the art after a study of the description, figures, and non-limiting Examples in this document.

### BRIEF DESCRIPTION OF THE DRAWINGS

FIG. 1 shows a generic membrane dehumidification system.

FIG. 2 shows a second embodiment of the present invention.

FIG. 3 is a schematic for a gas dehumidification test apparatus showing the flow splitting assemblies used to vary the feed gas relative humidity and ratio of retentate sweep to feed rates.

FIG. 4 shows an embodiment of a membrane module of the present invention.

FIG. 5 is a graph showing the results of a high humidity (rH=94% & T=31.4° C.) feed in an embodiment of the present invention. It shows retentate relative humidity (rH) vs. the percentage of the feed swept across the permeate side of the membrane. This figure shows a cutting in half of the rH for certain permeate operation pressures.

FIG. 6 is a graph showing medium humidity feeds (rH=55% & T=31.4° C.) to an embodiment of the present invention. It shows retentate relative humidity (rH) vs. the percentage of the feed swept across the permeate side of the membrane. Similar to high humidity feeds, the retentate rH is significantly reduced compared to the feed rH.

FIG. 7 is a graph showing low humidity feeds (rH=27% & T=31.4° C.) to an embodiment of the present invention. It shows retentate relative humidity (rH) vs. the percentage of the feed swept across the permeate side of the membrane. Similar to high and medium humidity feeds, the retentate rH is significantly reduced compared to the feed rH.

FIG. 8 is a graph showing reduction in retentate dew point vs. sweep flow for an embodiment of the present invention processing high humidity feeds (rH=94% & T=31.4° C.).

FIG. 9 is a graph showing reduction in retentate dew point vs. sweep flow for an embodiment of the present invention processing low humidity feeds (rH=27% & T=31.4° C.). The process may produce dehumidified gas with dew points <0° C.

FIG. 10 shows the removal of absolute humidity from the retentate stream vs. sweep flow for an embodiment of the present invention processing high humidity feeds (rH=94% & T=31.4° C.).

FIG. 11 shows calculated dehumidification efficiency, defined as latent heat removed over energy input to the system, of the single pass test unit (FIG. 4) showing an inverse relationship of process efficiency vs. sweep rate.

FIG. 12 shows a counter-current operation of two test units in series in accordance with an embodiment of the present invention. The addition of the second unit increased humidity removal from 47% to 75% (15.6 g/kg-DA to 21.8 g/kg-DA) without a significant increase in vacuum pump work.

FIG. 13 shows an embodiment of the present invention with a liquid water recovery unit downstream of the vacuum pump, followed by a recycle loop that connects the output gas from the liquid water recovery unit to the feed gas inlet.

FIG. 14 shows an embodiment of the present invention in which the sweep gas is ambient air that passes through an expansion valve prior to entering the system.

FIG. 15 is a graph of dehumidification efficiency, defined as latent heat removed over energy input into the system, for hot and humid gas feeds (rH=80%; T=50° C.; P=1 atm) vs. the percentage of the feed gas used as a sweep gas. Such a scenario can occur with drying applications.

FIG. 16 shows a configuration of an embodiment of the present invention that is part of a heating, ventilation, and air conditioning unit.

FIG. 17 shows a configuration of an embodiment of the present invention that is part of a drying system.

### DESCRIPTION OF EXEMPLARY EMBODIMENTS

Embodiments of the present invention generally relate to a membrane-based dehumidifying system and methods for using and implementing the system. In some embodiments the membrane system can use a fraction of the dehumidified gas as “a dehumidifying working fluid” (e.g., sweep gas) that passes through a sweep gas flow regulator prior to reenter the membrane housing. Without being bound by theory or mechanism, the combination of gas expansion and low absolute pressure sweep gas establish a driving force strong enough to achieve dehumidification efficiencies, defined as the ratio of latent heat removed to the energy consumed, greater than about 200%. Notably, in some embodiment the driving force is sufficient such that gas at ambient pressure can be dehumidified, and therefore the pressure drop across the membrane is at most about 1 atm. The produced gas can have a lower humidity than the feed gas. Some embodiments of the present invention produce gases with dew points less than about 0° C.

In the following description, various embodiments of the present invention will be disclosed. For purposes of explanation, specific numbers and/or configurations are set forth in order to prove a thorough understanding of the embodiments. However, it will also be apparent to one skilled in the art that the embodiments may be practiced without one or more of the specific details, or with other approaches and/or components. In other instances, well-known structures and/or operations are not shown or described in detail to avoid obscuring the embodiments. Furthermore, it is understood that the embodiments shown in the figures are illustrative representations and are not necessarily drawn to scale.

References throughout this specification to “one embodiment,” “an embodiment,” and so forth mean that a particular feature, structure, or characteristic described in connection with the embodiment is included in at least one embodiment. Thus, references to certain “embodiments” and so forth throughout this specification are not necessarily all referring to the same embodiment. Furthermore, the particular features, structures, or characteristics may be combined in any suitable manner in one or more embodiments.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of mass, weight, time, volume, concentration or percentage is meant to encompass variations of in some embodiments ±20%, in some embodiments +10%, in some embodiments ±5%, in some embodiments ±1%, in some embodiments ±0.5%, and in some embodiments ±0.1% from the specified amount, as such variations are appropriate to perform the disclosed method.

Some embodiments of the present invention are a low energy system for direct humidity control. Such embodiments directly meet long-felt needs that are not met with current commercially available technologies. Embodiments of the present invention remove humidity from gases in ways that are thought to be unattainable with conventional cooling coil dehumidification; namely, for example, isothermal dehumidification and the production of gases with dew points <0° C.

Some embodiments of the present invention use a portion of the retentate expanded through a sweep gas flow regulator (e.g., controllable valve) to create the desired combination of vacuum pressure and sweep gas flow rate. These embodiments dehumidify the feed gas, which then becomes the retentate. Alternative embodiments use the resulting spent sweep gas to produce liquid water that may or may not be potable.

Some embodiments of the present invention can be used in conjunction with heating, ventilation, and/or air conditioning systems (HVAC). Traditionally, in residential and smaller structures temperature control instead of humidity control is the norm. Humidity control using current technologies adds both capital and energy cost because of the need to add a reheat or desiccant system. However, in the context of air conditioning systems, the decoupling of latent and sensible heats reduces energy cost of the entire air conditioning system by avoiding over cooling and then reheating of the processed air. Lowering the moisture content of air within a building may also contribute to energy conservation. Low humidity buildings “feel” cooler and direct humidity control can eliminate the need to cool buildings for occupant comfort. Thus, some embodiments of the present invention that are used in conjunction with HVAC systems can reduce the net amount of energy required to make conditions within a structure comfortable. In addition, this may lead to increased public health by reducing the growth of bacteria, mold and mildew. Proper levels of humidity can also boost the body's immune function.

Accordingly, some embodiments of the present invention can be used for direct humidity control and decoupling of humidity control from air temperature control. Benefits of the invention include, for example, increased use of humidity control versus temperature control, smaller refrigerant plants leading to a decrease in the environmental impact of hydrofluorocarbon (HFC) refrigerant gases, positive economic impacts, and reduced costs.

The present invention does not use hydrofluorocarbons (HFCs) and may result in smaller cooling units containing smaller volumes of HFC working fluids since the cooling units will have reduced heat loads (e.g., reduced latent heat leaving only sensible heat loads). HFCs are strong greenhouse gases; therefore, the invention may benefit the public and reduce greenhouse gases in two ways: reduced energy use and reduced production of HFCs.

Aside from air conditioning, some embodiments of the present invention are directed to systems and processes to increase the energy efficiency of drying systems. Drying systems include clothes dryers, dryers used for pharmaceutical manufacturing, and the like. Some embodiments can isothermally dehumidify the exit gases from a dryer, and this dehumidified exit gas can then be recycled to the dryer so as to achieve direct recycling of the sensible heat to the dryer.

Specific examples of economic impacts of embodiments of the present invention, due to its ability to reduce humidity, include reduced bedding and linen replacement for hotels, decreased cleaning and maintenance of equipment and facilities, avoidance of extreme cases in which high humidity leads to the loss of buildings, and better humidity control for pharmaceutical manufacturing and packaging operations, which is also important for quality control during production and for shelf life during storage and packaging.

One superior and unexpected result of embodiments of the present invention is the size of the driving force for removing humidity from the feed gases. The dew point temperatures of the permeate may indicate the size of this driving force, and in some embodiments the permeate may have a dew point below the freezing point of water. In certain embodiments of the present invention, the permeate dew point was as low as minus 42° C. The conventional cooling coils used in the air conditioning industry physically may not reach driving forces for humidity removal that are this large, since ice formation on the coils sets the minimum dew point for a conventional coil at around 0° C. In addition, the invention may produce dehumidified gases as a product with dew points <0° C. Extremely dry product gases, with dew points <0° C., are typically impossible for convention cooling coils.

Some embodiments achieve dew points of about −42° C., about −40° C., about −35° C., about −30° C., about −25° C., about −20° C., about −15° C., about −10° C., about −5° C., about 0° C., about 5° C., about 10° C., about 15° C., about 20° C., about 25° C., about 30° C., about 35° C., or any value therebetween. Of course dew points may also be adjusted above or below this range to meet the needs of particular circumstances.

To person having ordinary skill in the art, the driving forces of the present invention that achieve product gases with sub-zero dew points and isothermal dehumidification would be superior and unexpected results. A person having ordinary skill in the art of membranes, looking at the similar results for existing high pressure gas drying units, would also find it to be superior and unexpected that embodiments of the membrane system work with low atmospheric pressure feeds, compared to the 100 psig or greater feeds required for known high pressure gas units.

Embodiments of the present invention include a technology that dehumidifies gases with low energy use that could garner significant market share from existing atmospheric pressure technologies (e.g. cooling coils and desiccants). As discussed above, one industry is the air conditioning industry. Also as discussed above, some embodiments of the present invention are applicable to the drying of solids; such as processing pharmaceuticals and drying clothes. Because clothes dryers currently account for about 5.8% of household energy use in a process recognized as being energy inefficient (1), those of ordinary skill will recognize the energy and cost advantages that may be achieved with certain embodiments of the present invention. Furthermore, some embodiments of the claimed subject matter are also capable of recovering gaseous water as a liquid, and such liquid water may be potable.

By using certain membranes, embodiments of the present invention dehumidify gases by creating a vapor pressure difference across such membranes. This removes water vapor from gas without changing the temperature of the gas. Thus, some embodiments of the present invention dehumidify gases isothermally. This one step process is less energy intensive and more controllable than certain previously known methods. The driving force, measured as the effective dew point temperatures of the “sweep gas,” can be below the freezing point of water.

Also, because some embodiments of the present invention are able to dehumidify gases that are at ambient pressure, the pressure difference across the membrane is at most about 1 atm, corresponding to the difference between the near vacuum on the permeate side of the system and the atmospheric pressure present on the retentate side

Adsorption (desiccants) and absorption (aqueous salts) exploit a phase change from vapor to a solid or liquid matrix. In contrast to phase change, other properties such as membrane permeability or molecular size can be exploited in the embodiments of the membrane-based separation system of the present invention. The ideal energy cost of separation by phase change (condensation, adsorption, or absorption) is approximately the water's heat-of-vaporization or the latent heat, while the energy cost of a membrane-based separation is only the cost of maintaining a partial pressure difference across the membrane.

Membrane-based gas dehumidification can have technical, energy, and economical advantages over other dehumidification technologies, such as absorption, adsorption, and refrigeration depending on the application (4). The US Department of Energy has previously recognized the low energy cost of membrane separations by including them in road maps for separation research (3). The advantages of simple installation, ease of operation, and low process cost have allowed successful applications to dehumidify high pressure compressed air (4). Table 1 contains polymers typically used for gas dehumidification along with some other novel membranes. Table 1 also contains the permeability or permeance along with selectivities. Permeability and permeance are measurements of the partial pressure normalized rate of water vapor transport through the membrane. Selectivity is the normalized rate of water transport divided by the gas transport through the same membrane, and is a measure of humidity separation using the referenced membrane.

TABLE 1
Polymers for high pressure gas dehumidification. Permeability given
as Permeability Coefficient (1 barrer = 3.348 × 10⁻¹⁶ mol/[m Pa s]) or
as Permeance (2.988 GPU = 1 × 10⁻⁹ mol/[m² Pa s]).

| | Water | | |
|---|---|---|---|
| | Permeability | Selectivity | |
| | (Barrer) or | vs. N₂ | Ref- |
| Material/Membrane | Permeance (GPU) | (air) | erence |
| Polymer Materials | | | |
| Polydimethylsiloxane (PDMS) | 40 000 barrer | 140 | (5) |
| Cellulose acetate (CA) | 60 000 barrer | 24 000 | (5) |
| Sulfonated polyethersulfone (SPES) | 15 000 barrer | 210 000 | (5) |
| Polyethylene oxide (PEO-PBT) | 100 000 barrer | 52 000 | (5) |
| Sulfonated poly(ether ether ketone) | 30 000 barrer | 300 000 | (5) |
| (SPEEK) | 1500 GPU | | |
| Poly(vinylalcohol)-EDTMPA | 997.7 GPU | | (11) |
| RTIL-Membranes | | | |
| [emim][Tf₂N] | 283 000 barrer | 3 800 | (6) |
| | 635 GPU | | |
| [N(4)111][Tf₂N] | 133 000 barrer | 3 300 | (6) |
| | 570 GPU | | |
| [emim][BF₄] | 354 000 barrer | 16 300 | (6) |
| | 1050 GPU | | |

However, the term “membrane”, as used herein, refers to any membrane that is selective for a substance that is desired to be removed from a feed gas. Thus, the term membrane is not limited to the membranes in Table 1. However, membranes can include, but are not limited to, room termperature ionic liquid membranes (RTIL), polymer membranes, water permeable membranes, and semi-permeable membranes. Furthermore, the membrane can be, but is not limited to, a flat membrane (plate and frame), a spiral wound membrane, a tubular membrane, a hollow fiber membrane, a capillary membrane, or combinations thereof. Each of these geometries has advantages. A geometry with a low pressure drop from the feed to the retentate may be advantageous in certain embodiments of the present invention.

Notably, the rate of transport through a membrane, including those listed above, is generically defined by the equation:

Q/A=j=(K/δ)ΔF=LᵢΔF (1)

where: j=Q/A is the flux of the transport species (Q=quantity transported, A=surface area of the membrane, K is the permeability coefficient of the membrane material, δ is the membrane thickness, Lᵢ=K/δ is the membrane permeance or the inverse of the resistance to flux and ΔF is the driving force or the difference in the transporting species' chemical potential across the membrane. There are many ways of reporting this chemical potential difference; however, the most practical means for water vapor transport is partial pressure. Those of skill in the art may utilize equation 1 to achieve desired mass transfer in an embodiment of the present invention.

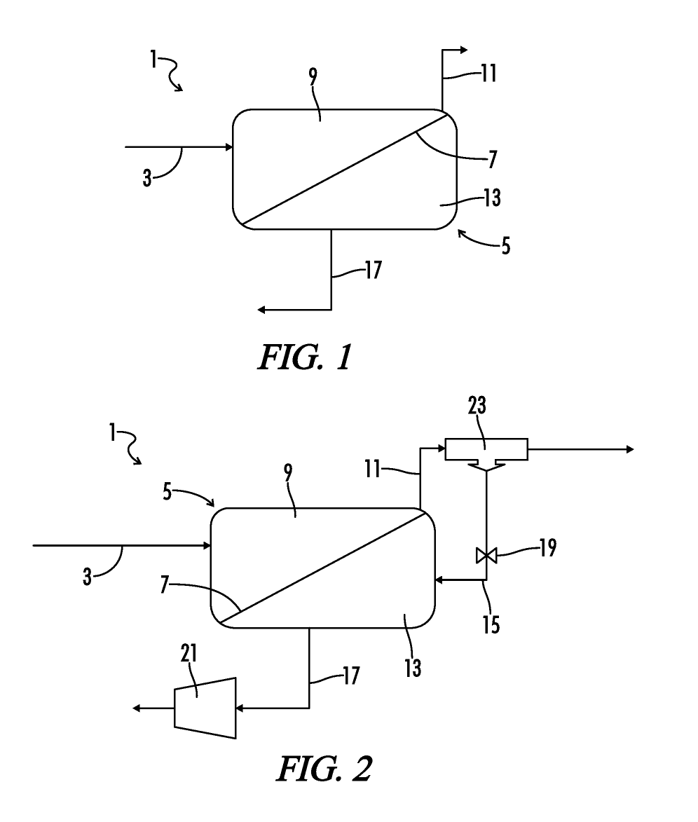

Looking now to FIG. 1, there is shown a generic membrane dehumidification system. A membrane apparatus consists of three streams or flows; the feed, the permeate, and the retentate. The product of the membrane process may be either the permeate or the retentate. In the context of air conditioning, the product is the retentate. Generic systems having this configuration generally remove water vapor from compressed gases and have pressure differences of 6.5 bar or more across the membrane, wherein the retentate side has a high pressure and the permeate side is at ambient pressure.

FIG. 2 shows an apparatus 1 for removing water vapor from gases at ambient pressures without requiring cooling to a target dew point that comprises a membrane housing 5. The membrane housing 5 (e.g., membrane module) comprises a water permeable membrane 7 with water selectivity verses the bulk gas (e.g., feed gas). The membrane 7 divides a first pressure side 9 (e.g., retentate side) and a second pressure side 13 (e.g., permeate side) of the membrane housing 5. Gas is supplied as a feed gas to the first pressure side 9 of the membrane housing 5 via a feed gas inlet 3. Upon passing through the first pressure side 9, the feed gas exits the first pressure side 9 via a feed gas outlet 11. In some embodiments, the feed gas exiting via the feed gas outlet 11 is a product gas, or, more specifically, is a dehumidified gas that can be used for a variety of applications. Sweep gas enters the second pressure 13 via a sweep gas inlet 15 and exits via a sweep gas outlet 17. The permeate that has passed through the membrane 7 (e.g., water) into second pressure side 13 of the membrane housing 5 also exits the membrane housing 5 via the sweep gas outlet 17.

The term “feed gas”, “bulk gas”, and the like, as used herein, refer to any gas mixture from which a substance can be removed by the membrane. In certain embodiments the substance to be removed is water, and more specifically, water vapor. In one embodiment, the apparatus is optimized to remove water from air at atmospheric pressure and temperature. Feed gases in other embodiments also include, but are not be limited to, methane, biomethane, ethane, ethylene, ethanol, butane, butene, butanol, and combinations thereof.

FIG. 2 shows how the retentate side 9 can receive the feed gas, contact the gas with the membrane 7 for mass transport of the water vapor through the membrane thereby producing a dehumidified gas in the retentate side 9 can exit the membrane housing 5 through the feed gas outlet 11 as the retentate. The feed gas exiting the feed gas outlet 11 (e.g., retentate) then passes through a flow splitter 23. The flow splitter 23 directs a re-directed portion of the feed gas exiting the retentate side 9 to the permeate side 13 as the sweep gas.

To aid mass transfer, a vacuum pump may lower the pressure of the permeate side 13 of the membrane housing 5 below the pressure in the retentate side 9 of the membrane housing 5. The gas, water, and other substances that do not pass through the membrane may exit the retentate side 9 of the membrane housing 5. The feed gas exiting the retentate side 9 may have a lower specific humidity compared to the feed gas that enters the retentate side 9.

Also as shown in FIG. 2, the permeate side 13 has a means for passing a sweep gas past the membrane 7, sweeping away the water vapor permeating through the membrane 7. In the illustrated embodiment, a flow splitter 23 for the retentate gas allows a fraction of the retentate gas to go through an sweep gas flow regulator 19 for use as the sweep gas. A pump 21 (e.g., vacuum pump) removes the sweep gas from the permeate side 13 of the membrane housing 5. The product can be the retentate for dehumidification and/or the permeate for water recovery.

In some embodiments, the sweep gas entering the permeate side 13 of the membrane housing 5 aids mass transfer by “sweeping” away permeate from the permeate side 13 of the membrane 7. In some embodiments this is achieved by using a sweep gas having a lower humidity than the permeate. By sweeping the permeate with a sweep gas, the apparatus 1 may achieve higher driving forces across the membranes and avoid high concentrations of the substance that the membrane is selective for (e.g., water) from building up on the permeate side 13 of the membrane 7.

The term “flow splitter”, as used herein, generally refers to any device or object that can split the flow of a fluid into two or more streams. In some embodiments the flow splitter is a T-junction that splits an incoming stream into two outgoing streams. Furthermore, the “re-directed portion of the feed gas exiting the first pressure side” can be any amount of the feed gas that exits the first pressure side. For instance, the re-directed portion can comprise anywhere from 0.1% to 99.9% of the feed gas exiting the first pressure side.

In some embodiments the re-directed portion of the feed gas exiting the first pressure side comprises about 0.1%, about 2.5%, about 5.0%, about 7.5%, about 10.0%, about 12.5%, about 15.0%, about 17.5%, about 20.0%, about 25%, about 30%, about 35%, about 40%, about 50%, about 60%, about 70%, about 80%, about 90%, about 99.9%, or any value therebetween of the feed gas exiting the first pressure side.

As discussed above, the permeate side 13 can operate at a vacuum pressure. As used herein, the terms “lower pressure”, “vacuum pressure”, “vacuum”, and the like generally refer to a pressure that is lower than a pressure in a first pressure side (e.g., retentate side) of a membrane housing. In some embodiments the vacuum pressure is any pressure below ambient pressure. In some embodiments vacuum pressure is about 50 mmHg-absolute, 100 mmHg-absolute, or 200 mmHg-absolute.

In some embodiments, a vacuum pressure is about 50 mmHg-absolute, about 100 mmHg-absolute, about 150 mmHg-absolute, about 200 mmHg-absolute, about 250 mmHg-absolute, about 300 mmHg-absolute, about 350 mmHg-absolute, about 400 mmHg-absolute, about 450 mmHg-absolute, about 500 mmHg-absolute, about 550 mmHg-absolute, about 600 mmHg-absolute, about 650 mmHg-absolute, about 700 mmHg-absolute, about 750 mmHg-absolute, about 800 mmHg-absolute, about 850 mmHg-absolute, about 900 mmHg-absolute, about 950 mmHg-absolute, about 1000 mmHg-absolute, or any value therebetween.

The term “ambient pressure”, as used herein, generally refers to a pressure that is equal to about the pressure in the atmosphere in which an apparatus 1 is located. Accordingly, in some applications the ambient pressure will be approximately 1 atm. However, ambient pressure may deviate due to atmospheric conditions, altitude, and the like. Furthermore, in some embodiments a feed gas is fed to the first pressure side 9 with a pump, fan, or the like, that can cause the pressure in the first pressure side 9 to be slightly greater than that in the surrounding atmosphere. Lastly, the ambient pressure in the first pressure side 9 can deviate in the first pressure side 9 because of pressure drops caused within the membrane housing 5.

As used herein, the term “sweep gas flow regulator” generally refers to any device that can control the flow of sweep gas into the permeate side and also allows a vacuum pressure to be created in the permeate side. Examples of sweep gas flow regulators include expansion valves, throttling devices, needle valves, other valve designs, capillary tubes, orifices, and the like. The sweep gas flow regulator may be located either inside (not shown), on (not shown), or outside the membrane housing. For instance, the sweep gas flow regulator may be located on a sweep gas flow inlet (FIG. 2), on the wall of the membrane housing, or on the membrane itself.

A sweep gas flow regulator on the membrane is one example of an internal regulator. In some embodiments the internal sweep gas flow regulator is a leak or orifice on the membrane. For some embodiments comprising an internal sweep gas flow regulator, the sweep gas inlet can also be internal and may or may not be the same element as the sweep gas flow regulator.

The terms “pump”, “vacuum pump”, and the like, as used herein, generally refer to any device that modulates gas pressure. In some embodiments the pump imparts low pressure or a vacuum in a structure. Those of skill in the art will be able to determine the appropriate pump to achieve desired pressures in specific embodiments, and will appreciate that pumps are not to be limited in structure, design, and the like, but instead merely need to displace a fluid by any means to modulate pressure. The pumps may be selected from any known pump that may achieve the results desired in terms of efficiency, water removal, capacity, and the like. Examples of pumps include, but are not limited to, reciprocating pumps, rotary pumps, screw pumps, peristaltic pumps, compressors, and centrifugal pumps. Pumps can function to, among other things, keep the permeate side at a lower pressure relative to the retentate side, which drives mass transfer across the membrane, and aids the sweep gas in sweeping the membrane.

FIG. 4 shows an embodiment of the present invention comprising a membrane housing 5, a membrane 7 that divides a first pressure side 9 and second pressure side 13 of the membrane housing 5, a feed gas inlet 3, a feed gas outlet 11, a sweep gas inlet 15, and a sweep gas outlet 12. In this particular embodiment, the feed gas inlet 3 and sweep gas inlet 15 are stainless steel pipes. The feed gas outlet 11 and sweep gas outlet 12 are openings that surround, respectively, the feed gas inlet 3 and sweep gas inlet 15. Because the first pressure side 9 has a higher pressure then the second pressure side 13, the membrane 7 is backed with a membrane support 8 that prevents the membrane 7 from caving in the direction of the second pressure side 13. The second pressure side 13 also comprises a glass bean bed 14.

FIG. 12 shows an embodiment of the present invention wherein two membrane housings 5a, 5b are arranged in series. Feed gas is fed to the series of membrane housings 5a, 5b via the first feed inlet 3a. Feed gas exits the first membrane housing 5a via the first feed gas outlet 11a and enters the second membrane housing 5b via the second feed gas inlet 3b. Feed gas exiting the second membrane housing 5a goes through a second feed gas outlet 11b and passes through a flow splitter 23. Subsequently, a re-directed portion of the feed gas goes through a sweep gas regulator 19 as the sweep gas, and the sweep gas enters the second pressure side 13b of the second membrane housing 5b. The sweep gas then progresses out through the second sweep gas outlet 13b, through the first sweep gas inlet 15a, into the second pressure side 13a of the first membrane housing 5a, out through the first sweep gas outlet 17a, and to the pump 21. Accordingly, the first feed gas outlet 11a equates to the second feed gas inlet 3b, and the second sweep gas outlet 17b equates to the first sweep gas inlet 15a.

The arrangement shown in FIG. 12 uses counter-current flow between the two membrane housings 5a, 5b. Some embodiments comprise a plurality of membrane housings, and the number of membrane housings arranged in series can be adjusted to any value that meets the needs of a particular circumstance. Furthermore, the flow between respective membrane housings can be co-current flow, counter-current flow, another flow configuration, or combinations thereof. Those of skill in the art will appreciate that flow configurations can be tailored to achieved desired results. Thus, FIG. 12 is illustrative of only one possible configuration wherein multiple membrane housings are arranged together to remove water from a feed gas, and the present invention should not be limited to the particular embodiment.

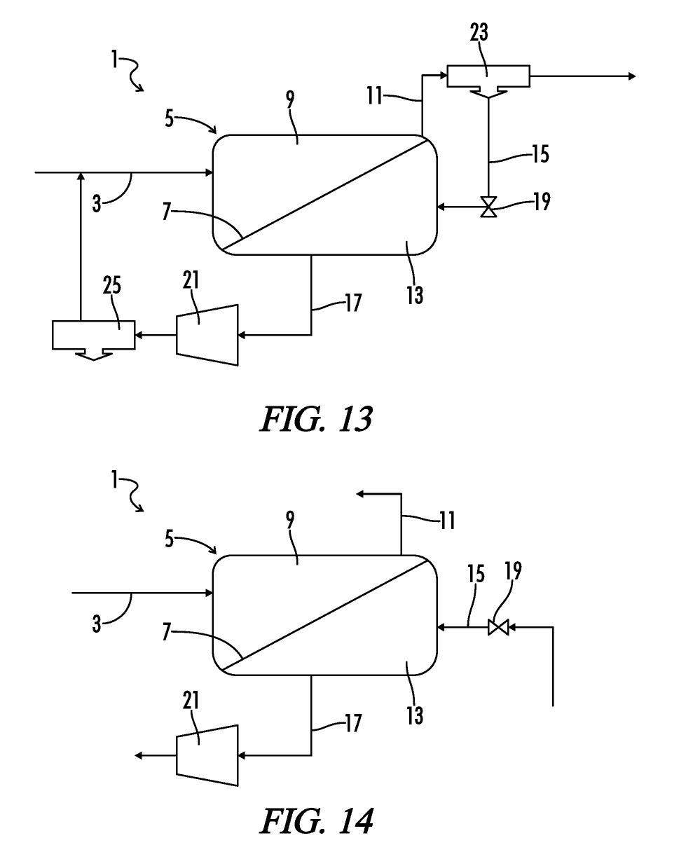

FIG. 13 shows an embodiment of the present inventions for water recovery. Such embodiments may be desirable for, among other things, the production of water from humid air or dehumidification of gases that should not be vented for economic or safety reasons. For example, in air conditioning systems the desired product is the retentate gas, or less humid gas than the feed gas. However, when the product is water, embodiments can comprise a water collection device 25 (e.g., liquid recovery unit). Because the water collection device 25 removes water from the gas that comes from the sweep gas outlet 17, embodiments can comprise a gas recycle 29 that recycles gas from the water collection device 25 to the feed gas inlet 3.

The term “water collection device”, as used herein, generally refers to any device that can collect water from a fluid that comprises water in gas, liquid, and/or solid form. In some embodiments the water collection device is a known cooling coil system that condenses water that is in the fluid in the sweep gas outlet. The water collection device can also be a device that comprises a membrane to separate water from the fluid in the sweep gas outlet. Any other suitable device may be utilized as a water collection device so long as it separates water from the fluid in the sweep gas outlet and can recover this water as a liquid.

The embodiment shown in FIG. 13 may also be used for removing water from chemical process gases. Chemical process gases include, but are not limited to, methane, biomethane, ethane, ethylene, ethanol, butane, butene, and butanol. When such gases are used in processes, it may be undesirable to vent the gases into the atmosphere. The embodiment in FIG. 13, having a gas recycle 29, allows dehumidification of process gases without gas losses. Also, while known membrane systems for the dehumidification of methane suffer from methane loss and are susceptible to polymer membranes plasticizing by water (16), the embodiment shown in FIG. 13 addresses this methane loss problem. Also, some membrane materials do not suffer from such plasticization by water, including the RTIL-membranes listed in Table 1 (6). Accordingly, embodiments of the present invention resolve previous problems that were encountered when removing water from certain gases.

FIG. 14 is an alternative embodiment of the present invention for use with hot and humid feeds that may be produced in drying processes such as, but not limited to, clothes drying or pharmaceutical manufacturing. In FIG. 14 also depicts an embodiment wherein the sweep gas is supplied from a source other than the retentate gas. In fact, the source of the sweep gas can be a re-directed portion of the feed gas exiting the first pressure side 9, atmospheric air, a preselected gas that is, for example, held in a separate container, or combinations thereof. FIG. 14 illustrates an embodiment wherein the sweep gas is atmospheric air or a preselected gas. In this embodiment a vacuum pump 21 draws the sweep gas through an expansion valve 19 and subsequently across the permeate side 13 of the membrane 7 to sweep the permeate side of the membrane 7. Using a gas other than the feed gas for the sweep gas decreases feed gas loss. The feed gas outlet 11 can also be directed towards a dryer or other process that requiresneeds relatively dehumidified gas.

Accordingly, the embodiments shown in FIGS. 13 and 14 are desirable for certain applications when treating gases that are harmful or dangerous if released into the atmosphere, such as, but not limited to, methane and bio-methane. Such embodiments are also desirable in systems designed to limit or eliminate losses of a feed gas. This can be the case when dehumidifying gases that are chemically valuable, such as methane, or energetically valuable, such as heated gases exiting a clothes dryer. In these applications, as well as others, releasing the feed gas into the atmosphere, including any portion of the feed gas that acts as a sweep gas, may be undesirable.

FIG. 16 shows an embodiment of the present invention being part of a heating ventilation and air conditioning (HVAC) system. The apparatus 1 is the same as that shown in FIG. 2, except that the sweep gas flow regulator 19 is not shown. The portion of the feed gas exiting the flow splitter 23 that is not re-directed to the sweep gas inlet 15 is instead directed to an HVAC system 30. After the gas passes through the HVAC system 30, it is directed to a building 31. Subsequently, the gas exits the building 31 either through a building vent 33 and/or is recycled back to the HVAC system 30. As discussed above, embodiments of the present invention that are part of a HVAC system lower the energy required to both remove water vapor from the feed gas as well as the amount of energy needed to make conditions comfortable within a building 31, since reducing humidity can reduce the extent to which a building 31 needs to be cooled to feel comfortable.

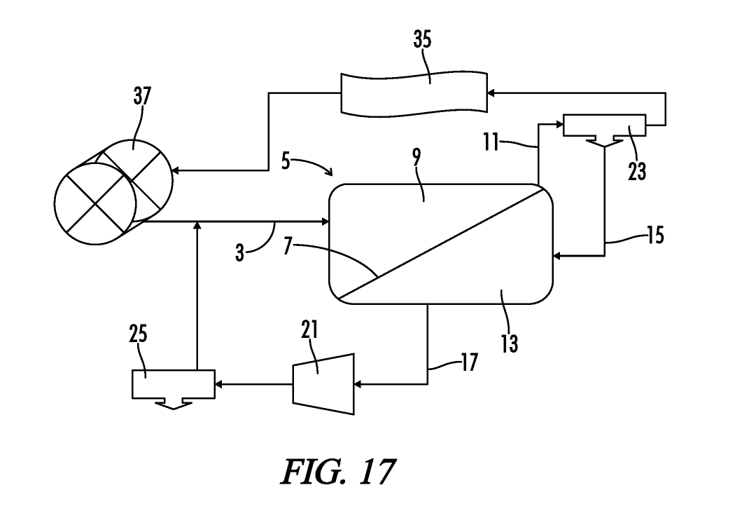

FIG. 17 shows an embodiment of the present invention being part of a drying system that comprises a heater 35 and a dryer drum 37. As in FIG. 16, the apparatus 1 is the same as that shown in FIG. 2, except that the sweep gas flow regulator 19 is not shown. The portion of the feed gas exiting the flow splitter 23 that is not re-directed to the sweep gas inlet 15 is directed to a heater 35. After passing the heater, the dehumidified hot air enters the dryer drum 37 to dry a substrate, such as clothes, pharmaceuticals, and the like. In the dryer drum 37 the gas will increase in water content as the substrate releases water vapor. This relatively warm and humid air is then recycled through a gas recycle 27 back to the feed gas inlet 3. In doing so, the embodiment minimizes energy loss that would otherwise occur by releasing the relatively warm air from the dryer drum 37 into the atmosphere. Thus, water vapor is removed from the feed gas without significantly cooling the retentate so that the retentate may be returned to the dryer for increased drying efficiency. Of course, the gas recycle (e.g., recycle loop) between the feed gas outlet 11 and the feed gas inlet 3 can pass the gas passes through any chosen device including, but not limited to, dryers, chemical plants, and the like, such as a dryer, and increases in humidity.

The embodiment also comprises a water recovery unit 25 that is located downstream from the pump 21 as well as a gas recycle 29 that recycles gas from the water collection device 25 back to the feed gas inlet 3, which also minimizes energy losses that would be caused by releasing heated gases. Accordingly, the depicted embodiment removes some or all the water from the substrate in the dryer drum 37 as liquid water in the water collection device 25, and the gases that are heated by the heater 35 are not released, which minimizes energy losses.

Further embodiments of the present invention comprise methods of utilizing the above described embodiments as well as variations thereof for removing vapor water from a gas. Some embodied methods comprise providing an apparatus for removing water vapor from gas, delivering a feed gas to the feed gas inlet of the apparatus, vacuuming a second pressure side of the apparatus with a pump to provide the sweep gas to the second pressure side and dryer water vapor through a membrane of the apparatus, and collecting a product.

As used herein, the term “providing” generally refers to, but is not limited to, making, using, lending, offering, selling, licensing, or leasing an embodied apparatus. Accordingly, the entity providing the apparatus may or may not actively participate in the removal of water vapor from a gas. Furthermore, as used herein, the term “delivering” generally refers to placing a gas in such a position that it enters the feed gas inlet of an apparatus. For example, delivering may be an active process where the feed gas inlet has a negative pressure and therefore draws the gas into the feed gas inlet. In other embodiments feed gas is delivered by a fan, pump, compressor, or the like to the feed gas inlet. “Vacuuming”, as used herein, is used to refer to the activation of a pump of an apparatus, which in turn imparts a low or vacuum pressure in the second pressure side of an apparatus and thereby moves a sweep gas through the second pressure side and/or drives mass transfer across the membrane of an apparatus.

Lastly, the term “collecting”, as used herein, refers to the physical collection, use, manufacture, or the like of a “product”. For example, collecting a product can comprise venting feed gas from a feed gas outlet into a building or structure so that the air within the structure is less humid that it would otherwise be. Collecting a product can also comprise collecting condensed water vapor from a water collection device and using it for drinking or non-drinking purposes. Collecting a product can also comprise using the feed gas from a feed gas outlet for various processes, such as drying clothes with a dryer, pharmaceutical process, defrosting windows, and so forth. Accordingly, those of skill in the art will appreciate that one or more different products may be collected from embodiments of the present invention for various different purposes.

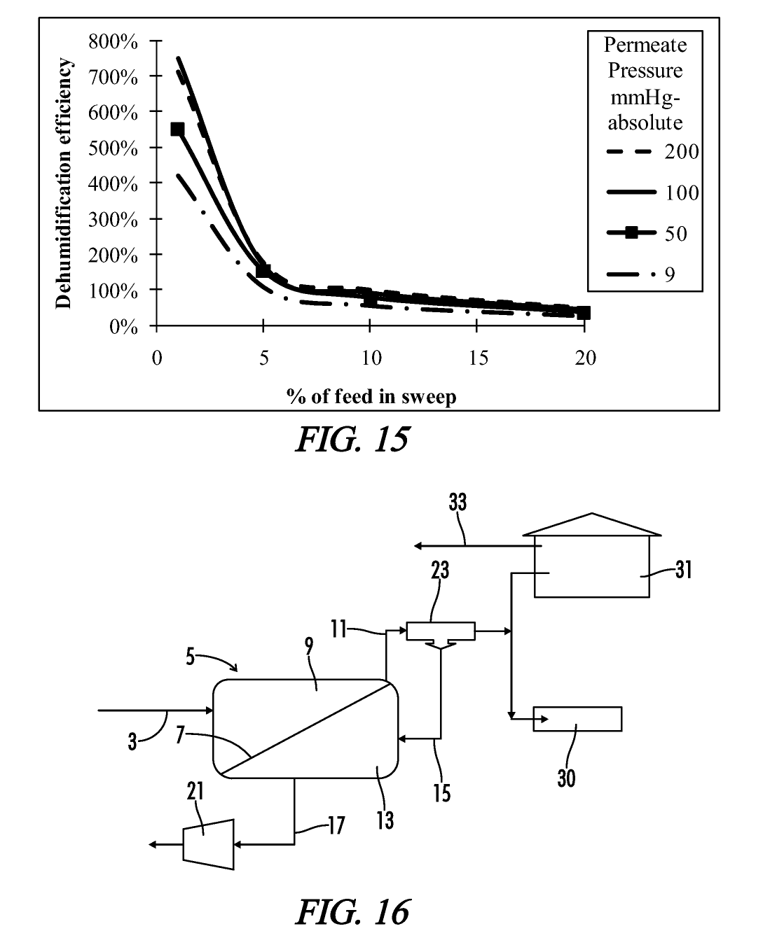

To illustrate the effectiveness of embodiments of the present invention used for drying processes, FIG. 15 shows dehumidification efficiency for an embodiment under conditions that imitate a drying process application such as, but not limited to, clothes drying. The feed gases for the experimental results shown in FIG. 15 were 50° C., 80% relative humidity, and 15.3 psia.

Another embodiment of the present invention is a membrane module that may be constructed unlike membrane modules currently in general use. Hollow fiber modules with the feed gas passing through the interior of the hollow fiber may have too high of a pressure drop. Fortunately, significant progress has been made in designing membrane modules with minimum feed gas pressure drop. Newbold et al. (9) in 1996 and Kneifel et al. (10) in 2006 published designs of membrane modules that may meet current needs. In the case of the Kneifel et al., designed air flow velocities of 4 meters/sec produced back pressures of less than 0.001 bars. This result is still useable for the present invention's purposes even though the membrane module used aqueous salts as an absorption-based dehumidification working fluid on the permeate side of the membrane.

In other embodiments, sweep flow rate and permeate pressure may not be totally independent of each other, and may work together to establish the necessary driving force to remove the desired level of humidity from the feed. The energy cost of this system may be dependent on sweep flow rate and/or permeate pressure. Decreasing the permeate pressure or increasing the sweep rate both may lead to larger vacuum pump energy demands via the following isothermal relationship:

Work=NRT*ln(760/Pₚ)/efficiency (2)

where N=number of moles pumped by the vacuum pump, which is the sum of the fraction of feed recycled as the permeate sweep plus the moles of water fluxed through the membrane, R=ideal gas constant, T=absolute temperature of the process. Pₚ=permeate absolute pressure in mmHg, and efficiency=vacuum pump isothermal efficiency. Note that in the energy relationship formula, the total moles in the sweep, N, has a direct relationship, while the permeate pressure, Pₚ, has a logarithmic relationship. Therefore, the sweep rate may be the more sensitive factor in reducing the energy cost.

Using [emim][BF₄]-membranes listed in Table 1, embodiments of the present invention were established to test the concept of the invention. These experiments underestimated the invention's performance (conservative data) because the membrane module used (FIG. 4) was not optimized for water separation. The reported membrane system performance may underestimate an optimized design's performance, yet positive comparisons are still possible even with these preliminary, potentially conservation values.

As discussed herein, embodiments of the present invention remove water vapor from gases using a water selective membrane. The driving force for water flux through the membranes can come from expanding a small portion of the retentate gas into the permeate space of the membrane module that is maintained at a lower absolute pressure than the feed/retentate side pressure. The combination of gas expansion and low absolute pressure sweep gas may establish a driving force strong enough to achieve dehumidification efficiencies >200%. In some embodiments dehumidification efficiency is about 200% to about 600% or even greater. Of course, dehumidification efficiencies of less than 100% are competitive with current technologies and may be desired in certain embodiments. In some embodiments the efficiency is 50%-100%. Dehumidification efficiency may also be adjusted to be about 1% to about 50%. Thus, the retentate gas humidity may be significantly reduced compared to the feed gas.

In the context of air conditioning systems, the invention could remove latent heat from the air prior to cooling via a conventional refrigeration vapor compression cycle (VCC) or evaporative cooling. Air conditioning systems using embodiments of the present invention for latent heat removal can use less energy overall than current VCC alone systems. The decoupling of latent and sensible heats may reduce energy cost of the entire air conditioning system by avoiding over cooling (followed by reheating) of the processed air.

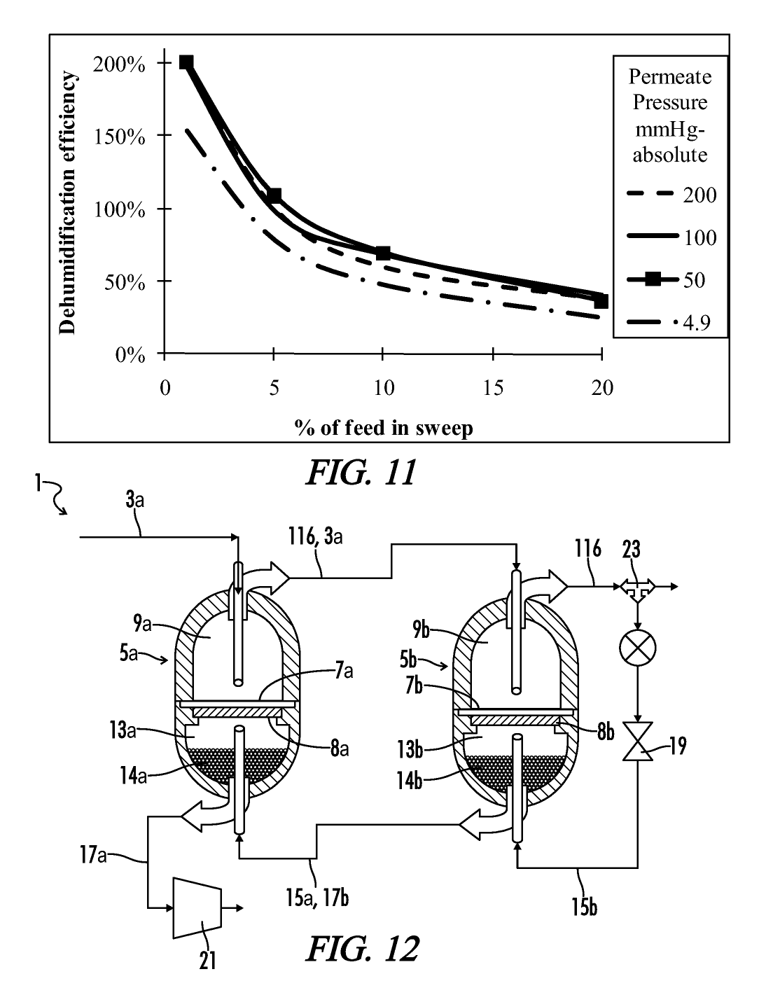

Some embodiments of the present invention can remove humidity with a small sweep rate and obtainable permeate pressures. Combining the removal of humidity (FIG. 10) with the dehumidification efficiency (FIG. 11), some embodiments achieve optimal performance at a permeate pressure near 50 mmHg, which is reachable using single stage reciprocating vacuum pumps. Good performance may also occur for some embodiments using higher permeate pressures such as 100 mmHg, which are within the reach of rotary water-sealed pumps.

Some embodiments of the invention are low energy systems for direct humidity control air conditioning. Therefore, embodiments of the present invention directly meet needs previously defined in the literature and engineering guidelines that are not met with current commercially available technologies. Embodiments of the present invention remove humidity from gases in ways that can not be achieved with certain conventional cooling coil dehumidification; namely, isothermal dehumidification and the production of gases with dew points <0° C. Both of these results may be superior and unexpected to those routinely engaged in air conditioning engineering.

Other non-limiting examples of applications for low energy dehumidification could also include defrosting car windows without the need to run the air conditioner, thus saving gas. Also, considering the permeate as the product, this invention may produce drinking water in remote locations, and may therefore be proper for humanitarian or military applications.

### EXAMPLES

The disclosed embodiments of the present invention are further illustrated by the following non-limiting examples.

### Example 1

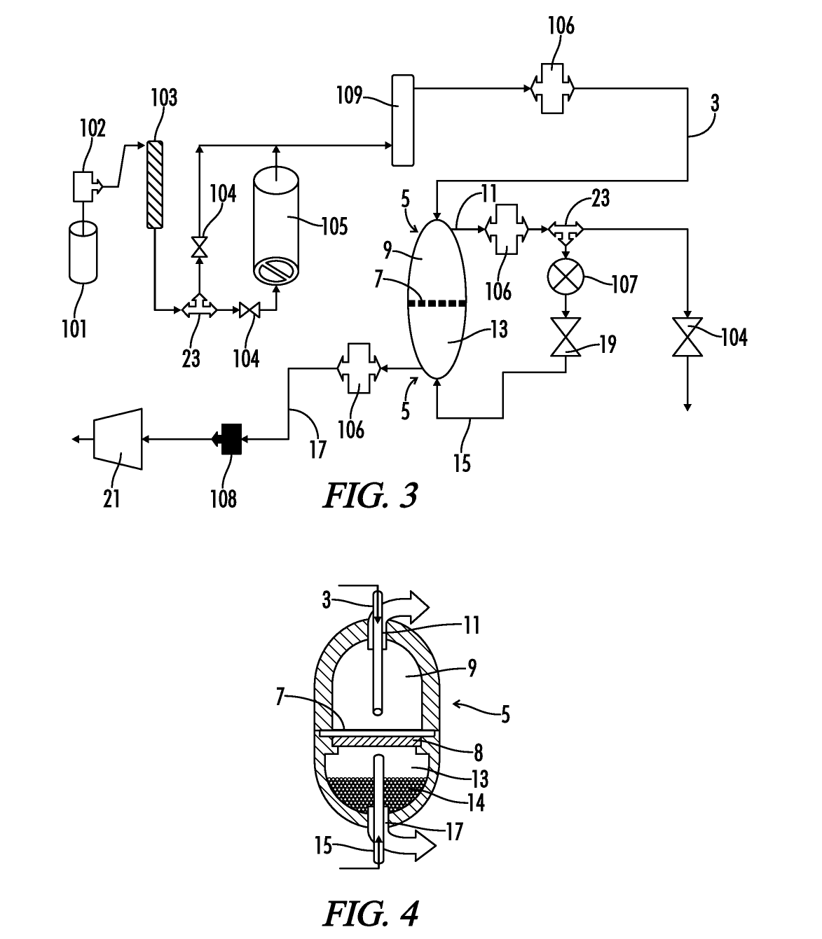

In this Example a system was designed to analyze the effectiveness of particular embodiments of the present invention for removing water vapor from certain feed gases. FIG. 3 shows the process diagram for the system that was designed to collect data of an embodiment set to operate at predetermined experimental conditions. All of the experiments used gas feeds of nitrogen (N₂) in which the operator could control the feed gas relative humidity over the range of 0% to 95%. An insulated box, maintained at a constant temperature of 31° C., contained the entire test apparatus. MKS Type 1179A Mass-Flo® controllers 102 (MFCs) controlled the flows of individual gases. All of the mass flow controllers 102 were operated by a MKS Type 247D Four-Channel Readout which allowed for accurate prolonged use of a specified flow rate. The feed gas flow rate was 80-sccm (standard cubic centimeters per minute).

Looking to FIG. 4, and particularly the feed gas part of the flow diagram, the test gas (N₂) flowed from a nitrogen gas tank 101 into a flow-splitting assembly of a piping-T 23 and needle valves 104 that the operator used to partition flow through both the by-pass and humidifier 105. The ratio of by-pass to humidifier 105 flows determined the feed gas humidity. The humidifier 105 was an air-stone at the bottom of a column of water. The humidifier 105 also contained plastic pall rings that extended above the water level to aid in demisting of the humidified air. The humidified gas stream then flowed through a stainless steel 300-mL vessel 109 to insure a stabilized, thermostated mixture.

Upon exiting the 300-mL vessel 109, the humidified gas entered the stainless steel dual chambered membrane module 5. The membrane module 5 was sealed from the atmosphere by the compression of two O-rings. As shown in FIG. 3, the membrane's 7 circular area exposed to the feed gas was 9.621-cm². The membrane module 5 had a stainless steel screen membrane support 8 with a mean pore diameter of 74 μm and a thickness of 1.66 mm (0.065 inches) (Martin Kurz & Co., Inc., Mineola, N.Y., part # TWM-80). The fluid dynamics within the membrane module 5 was an impingement flow on the center of the membrane 7 in both the retentate 9 and permeate chambers 13.

Three sensor ports 106 were in the experimental set-up to measure conditions of the Feed 3, Retentate 11, and Permeate 17 streams. The downstream ports were used to determine exit conditions of the retentate and permeate. All of the sensor ports 106 had calibrated Honeywell HIH-3610 Series relative humidity sensors. In addition the feed and retentate ports 106 had National Semiconductor LM34 temperature sensors. The retentate and permeate ports 106 had Omega PX139 pressure sensors.

Also, upon exiting the membrane module 5 the gas passed through a permeate port 106, a vacuum pressure controller 108, and a pump 21.

It was noted that the sweep flow rate and permeate pressure may not be totally independent of each other. Such is the case where, for example, the needed driving force across the membrane requires the permeate to be at “room neutral” (dew point of 13° C.). With zero recycle sweep the vacuum pump will need to operate at below 50 mmHg. However an absolute permeate pressure of 100 mmHg will produce the desired driving force with recycle sweeps as small as 5%. Surprisingly, some of the effective permeate dew points generated are below 0° C.; with zero recycle sweep this may require a permeate absolute pressure <5 mmHg. The test module was single pass co-current flow. For the specific embodiment, performance can be superior using counter-current flow in certain circumstances.

As discussed below, the data obtained from embodiments of the present invention illustrate the connection between sweep flow and permeate absolute pressure. The permeate absolute pressures covered were the vacuum pressures obtainable by either a rotary water sealed pump (absolute values >100 mmHg) or, for the lower tested vacuums, a reciprocating vacuum pump (12). Both of these types of pumps are commonly used in commercial applications. Other embodiments may use other pump designs. In summary, the permeate absolute pressures reported are 200 mmHg, 100 mmHg, 50 mmHg, and 5 mmHg.

### Example 2

This Example explains some of the superior and unexpected results observed in connection with the embodiment discussed in Example 1.

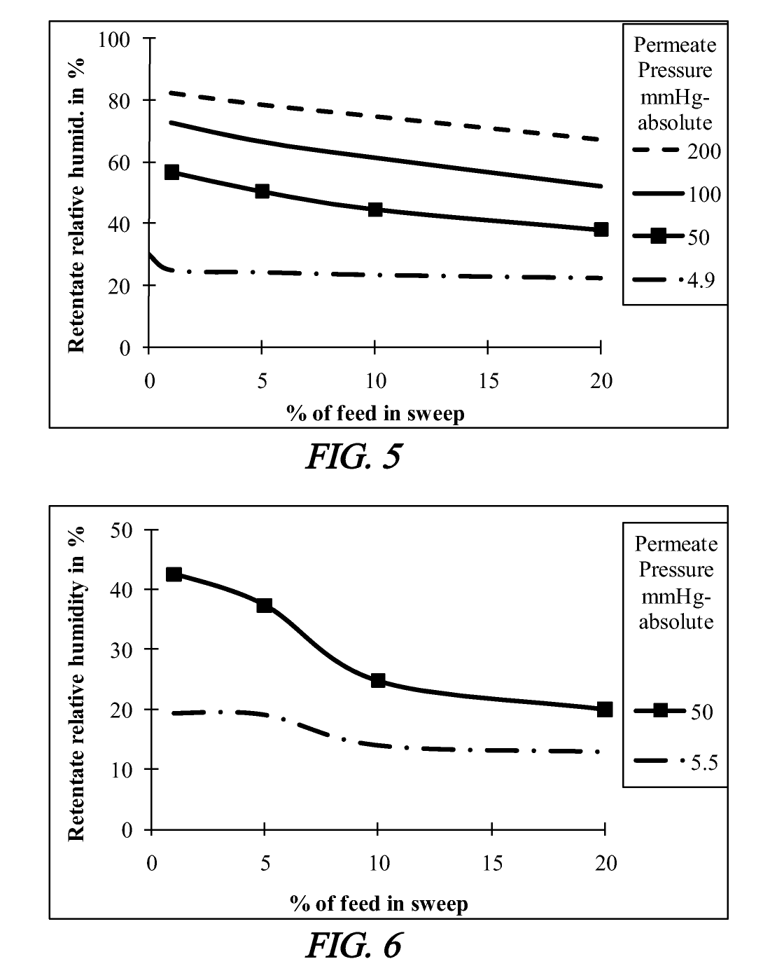

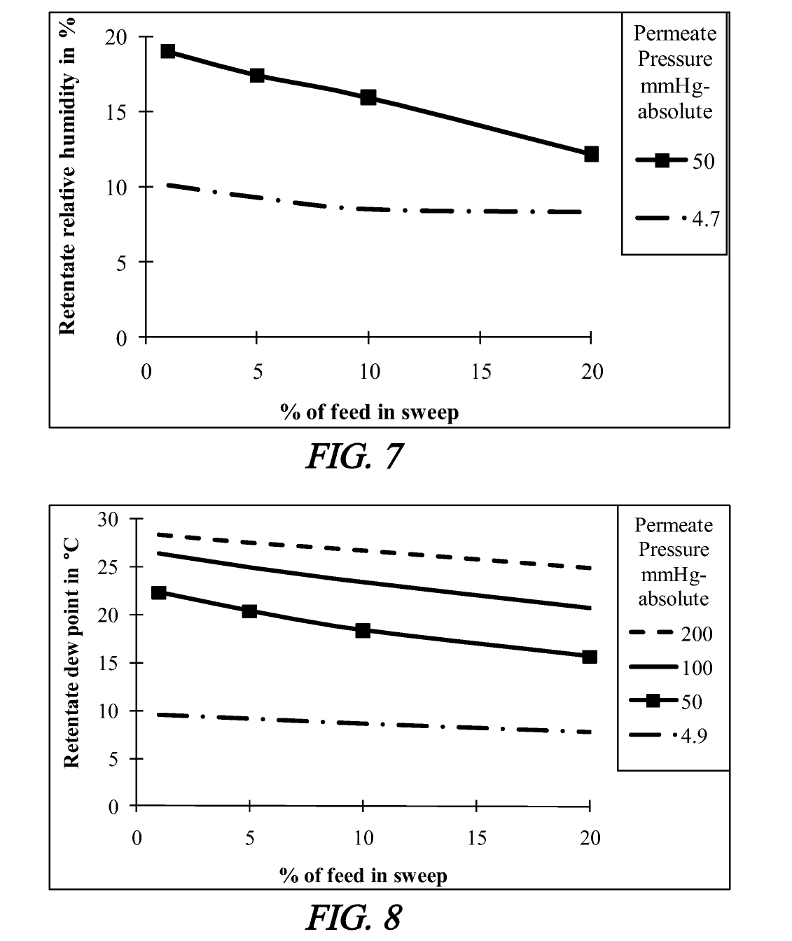

FIGS. 5-11 and 15 summarize the results from testing in connection with embodiments of the present invention. The following data was obtained using a [emim] [BF₄] membrane (Table 1), whose permeance closely matches the permeances reported for polymer membranes in Table 1. FIGS. 5-7 show the relative humidities in the retentate gas of the unit (FIG. 2). For dehumidification applications, the retentate is the product gas. FIG. 5 is for a high humidity feed with the average feed conditions of 94% rH, T=31.4° C., dew point=30.4° C., and a moisture content of 28.2 g-H₂O/Kg-DA. FIG. 5 illustrates that a single pass unit may cut the feed gas relative humidity in half using sweep gas pressures of 50 mmHg. Similar cuts in relative humidities may also occur when the feed has medium rH levels (55% rH in FIG. 6) and low rH levels (Feed rH=27% in FIG. 7).

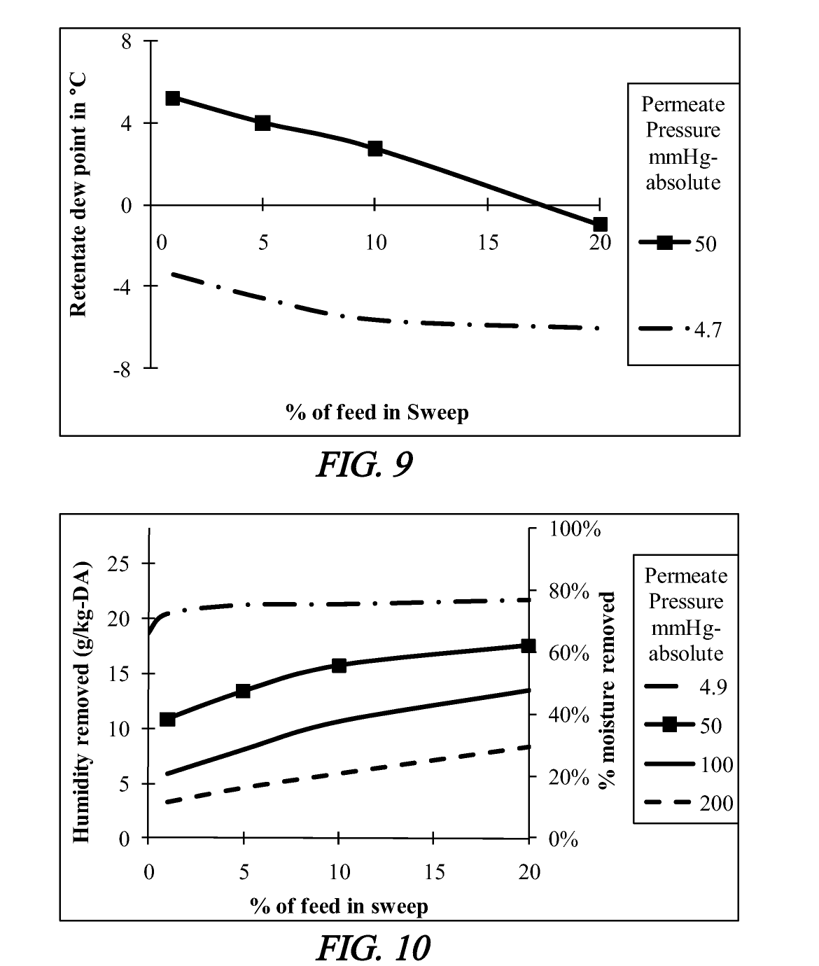

Alternatively, the data in FIGS. 5-7 may be reported as a reduction in the dew point between the feed and retentate gases as illustrated in FIG. 8 for high humidity feeds and FIG. 9 for low humidity feeds. FIG. 9 shows that it is possible to produce dehumidified gases with dew points below the freezing point of water. The production of dehumidified gases with dew points <0° C. is thought impossible when using traditional conventional cooling coils for dehumidification.

FIG. 10 shows the removal of absolute humidity (g-H₂O/kg-DA) verses the sweep flow rate for the tested permeated pressures. At the lowest tested pressure (5 mmHg) the sweep flow has a small influence on the percentage of humidity removed. At tested permeate pressures >50 mmHg, the sweep flow rate has a significant influence on the percentage removal of humidity. Using the 50 mmHg data as an example, the percentage of humidity removed goes from 38% to 62% as the sweep rate increases from 1% to 20% of the feed rate. The similar range of sweep rates for the 5 mmHg data only increased humidity removal from 72% to 77%.

### Example 3

This Example discusses the “dehumidification efficiencies” observed using the embodiment of Example 1.

Specifically, FIG. 11 shows the dehumidification efficiency of the single pass proof-of-concept test unit. It was observed that “dehumidification efficiency” can be equal to or far greater that 100%. The definition of dehumidification efficiency is the isothermal latent heat removed divided by the work required to remove the latent heat,

$$Dehumidification Efficiency = \frac{Latent Heat Removed}{Work Required} \qquad ( 3 )$$

To calculate the dehumidification efficiency per kilogram of dry air (kg-DA) produced by the unit, we first calculate the latent heat removed per kg-DA,

Latent Heat Removed=ΔH*λ (4)

where ΔH=absolute humidity change from feed to retentate (g/kg-DA) and λ=latent heat at the air stream temperature (kJ/g). The work required is equation 2, isothermal compressor work, scaled for the reduction in produced dehumidified gas by the fraction of the feed rate used in the permeate sweep,

$$Work Required = \frac{NRT}{pump efficiency} * ln ( \frac{760}{{P}_{p}} ) * \frac{1}{( 1 - Sweep \% )} \qquad ( 5 )$$

In eq. 5, it was assumed an isothermal compressor efficiency of 60% and accounted for both the moles of gas split from the retentate for the sweep and the moles of water fluxing through the membrane to calculate the total moles fed to the vacuum pump, N. Since condensation may be unnecessary to remove water vapor in a membrane unit, the latent heat carried by the water vapor may be larger than the vacuum pump work used to facilitate the permeation of the water vapor through the membrane. Therefore, combining eqs. 3 through 5 may produce dehumidification efficiencies greater that 200% (FIG. 11) or 600% (FIG. 15).

FIG. 11 shows that the overall efficiency of an embodiment of the process is inversely related to the sweep rate. Combining FIGS. 10 and 11, a trade-off between the rate of absolute humidity removed and the efficiency of the process is seen. Factoring removal and efficiency together, the best operating pressure for certain embodiments can be around 50 mmHg; however, good performance may occur for higher operation pressures such as 100 mmHg.

### Example 4

Examples 1 to 3 discuss observations made for a single pass embodiment. However, two units may be run in series with the sweep gas from the last unit flowing counter-current as the sweep for the first unit, for example. FIG. 12, in essence, combines the results reported in FIGS. 5 and 6. In this arrangement, FIG. 12 shows the relationship for a 10% sweep using a permeate pressure of 50 mmHg. In some embodiments it was found that two unit arrangements do not significantly increase the work required by the pump compared to the embodied single unit's data previously discussed. However, it was observed that an embodiment having a second unit in counter-current flow can increase the percentage of humidity removed from 47% to 75%, decrease the produced relative humidity from 45% to 25%, and decrease the produced gas' dew point from 18.3° C. to 9.1° C.

### Example 5

In this Example the performance of embodiments of the present invention for high temperature drying applications were analyzed. Embodiments were tested at elevated temperatures (50° C.) and showed similar absolute humidity removal to those reported in FIG. 10. The humidity removed, at 50° C., ranged from 13 g/kg to 16 g/kg for the 50 mmHg permeate pressure condition. In these high temperature tests the average feed conditions were 80% rH, T=50° C., dew point=46.6° C., and a moisture content of 68.3 g-H₂O/kg-DA. These feed conditions may be similar to those of gases exiting clothes dryers. As such, this high temperature data may speak to the potential application of the invention to increase the energy efficiency of drying processes, such as clothes dryers or pharmaceutical manufacturing, by isothermally dehumidifying the exit gases allowing the direct recycling of the sensible heat to the dryer.

### Example 6

In this Example the effective permeate dew points obtained with the embodiments of the above Examples were analyzed. While the following does not directly speak to application performance, it helps contrast embodiments of the invention against conventional cooling coils used for building dehumidification and may provide further evidence of a surprising result. The driving force for dehumidification using cooling coils may be the establishment of a temperature on the coils below the dew point of the air being dehumidified. The driving force for membranes may also be related to the dew point of the gas on the permeate side of the membrane. Tables 2-4 show this effective dew point driving force for the various feed conditions discussed. Many of these permeate dew points are below the freezing point of water. This sub-zero effective coil temperature may be a surprising and unexpected result for someone used to working with conventional dehumidification technologies.

TABLE 2
Effective permeate dew point for embodiments using feeds with 94% rH
and dew point = 30.5° C. This is a measure of the effective humidity
removing driving force generated by the system.
Percentage of Feed Recycled as Permeate Sweep

| Permeate Pressure | | | | |
|---|---|---|---|---|
| (mmHg, absolute) | 1% | 5% | 10% | 20% |
| 5 | −3.6° C. | −6.8° C. | −10.0° C. | −16.2° C. |
| 50 | 21.3° C. | 18.4° C. | 15.1° C. | 9.6° C. |
| 100 | 26.0° C. | 24.1° C. | 21.8° C. | 17.3° C. |
| 200 | 28.2° C. | 27.0° C. | 25.9° C. | 22.9° C. |

TABLE 3
Effective permeate dew point for embodiments using feeds with
55% rH and dew point = 21.3° C.
Percentage of Feed Recycled as Permeate Sweep

| Permeate Pressure | | | | |
|---|---|---|---|---|
| (mmHg, absolute) | 1% | 5% | 10% | 20% |
| 5 | −6.6° C. | −9.9° C. | −18.3° C. | −29.1° C. |
| 50 | 16.4° C. | 13.3° C. | 5.4° C. | −0.8° C. |

TABLE 4
Effective permeate dew pt. for embodiments using feeds with 27% rH and
dew point = 10.2° C. This is a measure of the effective humidity removing
driving force generated by the system.
Percentage of Feed Recycled as Permeate Sweep

| Permeate Pressure | | | | |
|---|---|---|---|---|
| (mmHg, absolute) | 1% | 5% | 10% | 20% |
| 5 | −15.0° C. | −21.0° C. | −29.8° C. | −41.7° C. |
| 50 | 3.7° C. | 1.5° C. | −1.0° C. | −8.2° C. |

The invention thus being described, and as discussed above, it will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the Specification, including the disclosed embodiments, tests, data, and examples, be considered as exemplary only, and not intended to limit the scope and spirit of the invention.

### TERMS AND NOMENCLATURE

ASHRAE: American Society of Heating, Refrigeration, and Air Conditioning Engineers

Dry Bulb Temperature: The temperature of air measured directly by a thermometer.

Expansion Valve: Any throttling device, such as, but not limited to, a valve, capillary tube, throttle, or an orifice.

g/kg-DA: A humidity unit notation meaning grams of water vapor per kg of dry air.

Humidity: A measure of the amount of water vapor in the air stream.

Humidity Control: A process to actively control both the sensible heat and the latent heat of a space or air mass to a range of dry bulb and wet bulb temperatures. Both of these temperatures are measured and the process adjusted to achieve both desired ranges.

Latent Heat: The energy added to or removed from an air mass by increasing or decreasing the humidity in the air mass.

Relative Humidity: Quantifies the amount of water vapor in the air as a percentage of the maximum amount of water vapor air can hold at the Dry Bulb Temperature of the air.

Sensible Heat: The energy added to or removed from an air mass to change the Dry Bulb Temperature

VCC: Vapor Compression (refrigeration) Cycle

### REFERENCES

Throughout this application various publications are referenced. All such references, including those listed below, are incorporated herein by reference.
1. Condensing dryers with enhanced dehumidification using surface tension elements. Cochran, Michael, et al. 2009, Applied Thermal Engineering, pp. 723-731.
2. Air Products, Inc. CACTUS® membrane air dryers. s.l.: http://www.airproducts.com/Products/Equipment/PRISMMembranes/page03.htm, 2010. Product Literature.
3. Separations research needs for the 21st century. Noble, R. and Agrawal, R. 9, 2005, Industrial and Engineering Chemistry Research, Vol. 44, pp. 2887-2892.
4. P(AA-AMPS)-PVA/polysulfone composite hollow fiber membranes for propylene dehumidification. Pan, F., et al. 2008, Journal of Membrane Science, Vol. 323, pp. 395-403.
5. Flue gas dehydration using polymer membranes. Sijbesma, H., et al. 2008, Journal of membrane science, Vol. 313, pp. 263-276.
6. Testing and evaluation of room temperature ionic liquid (RTIL) membranes for gas dehumidification. Scovazzo, Paul. 2010, Journal of Membrane Science, Vol. 355, pp. 7-17.
7. A novel air conditioning system, membrane air drying and evaporative cooling. El-Dessouky, H. T., Ettounkey, H. M. and Bouhamra, W. 2000, Trans IChemE, Vol. 78, pp. 999-1009.
8. The effect of a support layer on the permeability of water vapor in asymmetric composite membranes. Liu, L., et al. 2001, Separation Science and Technology, Vol. 36, pp. 3701-3720.
9. Performance of a membrane-based condensate-recovery heat exchanger. Newbold, D. D., et al. Monterey, C A: SAE Technical Paper Series, 1996. 26th International Conference on Environmental Systems. p. SAE Technical Paper 961356.
10. Hollow fiber membrane contactor for air humidity control: Modules and membranes. Kneifel, K., et al. 2006, Journal of Membrane Science, Vol. 276, pp. 241-251.
11. Enhanced dehumidification performance of PVA membranes by tuning the water state through incorporating organophosphorus acid. Pan, F., et al. 2008, Journal of Membrane Science, Vol. 325, pp. 727-734.
12. Perry's Handbook of Chemical Engineering, 8th edition. [book auth.] Perry's. Transport and storage of fluids. New York: McGraw Hill, 2008, pp. 10-58 to 10-60.
13. Separation of gases by diffusion and gaseous permeation—Applications of gaseous permeation to the dehdration of national gas. Charpin, J. 1990, Revue Roumaine de Chimie, Vol. 35, pp. 815-820.
14. Interactions of polyether-polyurethanes with water vapour and water-methane separation selectivity. Di Landro, L., Pegoraro, M. and Bordogna, L. 1991, Journal of Membrane Science, Vol. 64, pp. 229-236.
15. Solubility and transport of water vapor in some 6FDA-based polyimides. Lokhandwala, K. A., Nakakatti, S. M. and Stern, S. A. 1995, Journal of Polymer Science, Part B: Poly Phys., Vol. 33, pp. 965-976.
16. Polymeric membranes for natural gas conditioning. Feng, H., Zhang, H. and Xu, L. 2007, Energy Sources, Part A, Vol. 29, p. 1269.
17. Membrane porosity and hydrophilic membrane-based dehumidification performance. Scovazzo, Paul, Hoehn, Alex and Todd, Paul. 2000, Journal of Membrane Science, Vol. 167, pp. 217-225.

1. A system for removing water vapor from gas, comprising:
an apparatus that includes:
a membrane;
a membrane housing comprising a first pressure side and a second pressure side, with the membrane dividing the first pressure side from the second pressure side;
a feed gas inlet directing a feed gas with a first humidity into the first pressure side and in contact with the membrane;
a feed gas outlet on the first pressure side;
a sweep gas inlet directing a sweep gas with a second humidity into the second pressure side and in contact with the membrane;
a sweep gas outlet on the second pressure side allowing the sweep gas and a permeate to exit the membrane housing;
a sweep gas flow regulator to direct the sweep gas into the second pressure side; and
a pump that imparts a lower pressure in the second pressure side than a pressure in the first pressure side, the pump directing the sweep gas through the second pressure side;
wherein water vapor from the feed gas is drawn through the membrane into the second pressure side as the permeate.

2. The system of claim 1, wherein the sweep gas flow regulator is an expansion valve, a throttling device, a valve, a capillary tube, or an orifice.

3-5. (canceled)

6. The system of claim 1, further comprising a flow splitter to direct a re-directed portion of the feed gas exiting the first pressure side to the second pressure side as the sweep gas.

7-10. (canceled)

11. The system of claim 1, wherein the feed gas enters the first pressure side at ambient pressure.

12-14. (canceled)

15. The system of claim 1, further comprising a water collection device to collect condensed water vapor from the feed gas.

16-17. (canceled)

18. The system of claim 1, wherein the membrane is a spiral wound membrane, a tubular membrane, a hollow fiber membrane, a flat sheet membrane, a capillary membrane, or combinations thereof.

19. The system of claim 1, wherein the membrane is a water permeable membrane, a semi-permeable membrane, or combinations thereof.

20. The system of claim 1, wherein the membrane comprises polydimethylsiloxane, cellulose acetate, sulfonated polyethersulfone, polyethylene oxide, sulfonated poly(ether ether ketone), poly(vinylalcohol)-EDTMPA, [emim][Tf₂N], [N(4)111][Tf₂N], [emim][BF₄], or combinations thereof.

21. The system of claim 1, wherein the feed gas in the feed gas outlet has a dew point of about −42° C. to about 35° C.

22. The system of claim 1, wherein the apparatus achieves a dehumidification efficiency of about 50% to about 600%.

23. (canceled)

24. The system of claim 1, further comprising a recycle loop that is in fluid communication with the sweep gas outlet and the feed gas inlet.

25. (canceled)

26. The system of claim 1, being a part of a heating system, a ventilation system, an air conditioning system, a drying system, a liquid recovery system, or combinations thereof.

27. The system of claim 26, wherein the feed gas in the feed gas outlet enters the drying system.

28. The system of claim 26, wherein the feed gas includes a dryer gas from an outlet of the drying system.

29. The system of claim 1, wherein the sweep gas comprises a portion of the feed gas.

30. A method for manufacturing the apparatus of claim 1.

31. A method for removing water vapor from gas, comprising:
providing an apparatus for removing water vapor from a feed gas, the apparatus including:
a membrane;
a membrane housing comprising a first pressure side and a second pressure side, with the membrane dividing the first pressure side from the second pressure side;
a feed gas inlet directing the feed gas with a first humidity into the first pressure side and in contact with the membrane;
a feed gas outlet on the first pressure side;
a sweep gas inlet directing a sweep gas with a second humidity into the second pressure side and in contact with the membrane;
a sweep gas outlet on the second pressure side allowing the sweep gas and a permeate to exit the membrane housing;
a sweep gas flow regulator to direct the sweep gas into the second pressure side; and
a pump that imparts a lower pressure in the second pressure side than a pressure in the first pressure side, the pump directing the sweep gas through the second pressure side;
wherein water vapor from the feed gas is drawn through the membrane into the second pressure side as the permeate;
delivering the feed gas to the feed gas inlet;
vacuuming the second pressure side with the pump to provide the sweep gas to the second pressure side and to drive water vapor through the membrane; and
collecting a product.

32. The method of claim 31, wherein the product is the feed gas in the feed gas outlet.

33. The method of claim 31, wherein the feed gas is air, oxygen, nitrogen, methane, biomethane, ethane, ethylene, ethanol, butane, butanol, or combinations thereof.

34. The method of claim 31, wherein the sweep gas includes air, a portion of the feed gas from the feed gas outlet, a preselected gas, or combinations thereof.

35. The method of claim 31, wherein the sweep gas flow regulator is an expansion valve, a throttling device, a valve, a capillary tube, or an orifice.

36. (canceled)

37. The method of claim 31, further comprising a flow splitter to direct a re-directed portion of the feed gas exiting the first pressure side to the second pressure side as the sweep gas.

38-39. (canceled)

40. The method of claim 31, wherein the feed gas enters the first pressure side at ambient pressure.

41. (canceled)

42. The method of claim 31, further comprising a water collection device to collect condensed water vapor from the feed gas.

43-44. (canceled)

45. The method of claim 31, wherein the membrane is a spiral wound membrane, a tubular membrane, a hollow fiber membrane, a flat sheet membrane, a capillary membrane, or combinations thereof.

46. (canceled)

47. The method of claim 31, wherein the membrane comprises polydimethylsiloxane, cellulose acetate, sulfonated polyethersulfone, polyethylene oxide, sulfonated poly(ether ether ketone), poly(vinylalcohol)-EDTMPA, [emim][Tf₂N], [N(4)111][Tf₂N], [emim][BF₄], or combinations thereof

48. (canceled)

49. The method of claim 31, further comprising a recycle loop that is in fluid communication with the sweep gas outlet and the feed gas inlet.

50. (canceled)

51. The method of claim 31, wherein the sweep gas comprises a portion of the feed gas.

52. (canceled)

53. The system of claim 1, comprising a plurality of the apparatuses.

54. The system of claim 1, wherein the feed gas enters the first pressure side at ambient pressure, and wherein the sweep gas comprises a portion of the feed gas.

55. The method of claim 31, wherein the feed gas enters the first pressure side at ambient pressure, and wherein the sweep gas comprises a portion of the feed gas.
